(19) United States
(12) Patent Application Publication
(10) Pub. No.: US 2004/0190555 A1
(43) Pub. Date: Sep. 30, 2004

(54) Multithreaded, multiphase processor utilizing next-phase signals

(76) Inventor: David Q. Meng, Union City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/404,959

(22) Filed: Mar. 31, 2003

(51) Int. Cl. H04J 3/24

(52) U.S. Cl. 370/474; 718/107

(57) ABSTRACT

A thread receives a first execution signal to execute a phase to process a data unit. The thread executes the phase, as a result of receiving the first execution signal, and when the phase is complete, the thread transmits a second execution signal to parallel thread, to indicate that the parallel thread may execute a corresponding phase to process a second data unit.

### TECHNICAL FIELD OF THE INVENTION

Embodiments of the invention are generally related to the field of data networking and, in particular, to a multithreaded, multiphase processor and associated methods.

### BACKGROUND OF THE INVENTION

In a packet-switching network, a data stream is divided into smaller blocks of data for transmission across the network. In general, a block of data is encapsulated, i.e., a header is added to the block of data, to create a data unit commonly referred to as a segment. The segment may be further encapsulated by adding another header, to create a data unit commonly referred to as a datagram. A datagram, or portion thereof, is further encapsulated and carried across the network in a data unit commonly referred to as a frame. Thus, each data unit includes a header and a payload, wherein the payload for a segment includes the original block of data, the payload for a datagram includes a segment, and the payload for a frame includes at least a portion of a datagram. In the remainder of this description, the term “packet” will be used to refer to a datagram.

When frames arrive at their destination, frames belonging to the same packet are decapsulated, i.e., their headers are removed, and their payloads are reassembled into the original packet, which is decapsulated to recover a segment, which is decapsulated to recover the original block of data. Frames belonging to the same packet may also be reassembled at a network switch. Specifically, frames that contain a certain amount of data per frame are received at the network switch from one attached network and reassembled into a packet. The packet then is divided into frames that contain a different amount of data per frame, as may be required for transmission over another attached network.

A destination device or a network switch may contain a programmable central processing unit, also referred to as a processor, that runs a software program for reassembling frames into packets. When a destination device or network switch receives frames, the processor stores frame payloads belonging to the same packet in memory one frame payload at a time until all of the payloads belonging to the same packet are stored in memory, for example, as part of the process for reassembling the packet.

Storing frame payloads in memory on a per-frame basis takes time. Specifically, the processor waits for completion of each store operation prior to performing other operations, such as determining whether each frame belonging to the same packet has arrived in the correct sequence relative to each other so that the packet may be reassembled.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating a processor according to an embodiment of the invention.

FIG. 2 is a block diagram illustrating a processing stage of a processor according to an embodiment of the invention.

FIG. 3 and FIG. 4 are a flow chart illustrating a method of processing a data unit according to an embodiment of the invention.

FIG. 5 is a flow chart illustrating a method of a first phase according to an embodiment of the invention.

FIG. 6 is a flow chart illustrating a method of a second phase according to an embodiment of the invention.

FIG. 7 is a flow chart illustrating a method of a third phase according to an embodiment of the invention.

FIG. 8 is a flow chart illustrating a method of a final phase according to an embodiment of the invention.

FIG. 9 is a block diagram illustrating one embodiment of an electronic system.

### DETAILED DESCRIPTION OF THE INVENTION

A multithreaded, multiphase processor and associated methods are described. In the following description, for purposes of explanation, numerous specific details are set forth. It will be apparent, however, to one skilled in the art that embodiments of the invention can be practiced without these specific details. In other instances, structures and devices are shown in block diagram form in order to avoid obscuring the understanding of this description.

A processor may include multiple threads that process data units in multiple phases. A thread is a single execution path within a program. Multiple threads execute concurrently within a single program.

A phase is an execution of a section or segment of a thread. When a data unit arrives at the processor via an interface, the interface activates a thread, which executes a first phase. The thread completes the first phase, and waits for a next-phase signal (NPS), which indicates that the thread may proceed to a second phase. Typically, a parallel thread that has already executed a corresponding phase, in this case a second phase, provides the NPS.

When the thread receives the NPS, the thread executes the second phase. When the thread completes the second phase, the thread provides a NPS to yet another parallel thread, to indicate that the parallel thread may execute its second phase. Furthermore, the thread waits to receive another NPS to proceed to a third phase. The thread continues to receive next processing signals, execute phases, and transmit next processing signals, until the thread completes a final phase. When the thread completes the final phase, the thread indicates, for example, to the interface, that the thread is available to process another data unit.

As data units arrive at the processor, a data unit belonging to a larger data unit may be immediately followed by another data unit belonging to the same larger data unit, or by a data unit belonging to a different larger data unit. The processor processes data units belonging to the same larger data unit together, e.g., frames belonging to the same packet are reassembled into the packet, regardless of whether the data units arrive one after another or are interleaved with data units belonging to a different larger data unit.

When processing data units, threads may access a memory location shared with other threads. During a phase, a first thread may use data in a shared memory location to process a data unit, prior to access of the shared memory location by a second thread processing a second data unit belonging to the same larger data unit. Modification of the data in the shared memory location prior to access by the first thread may cause the first thread to process its data unit so that other data units belonging to the same larger data unit are processed incorrectly.

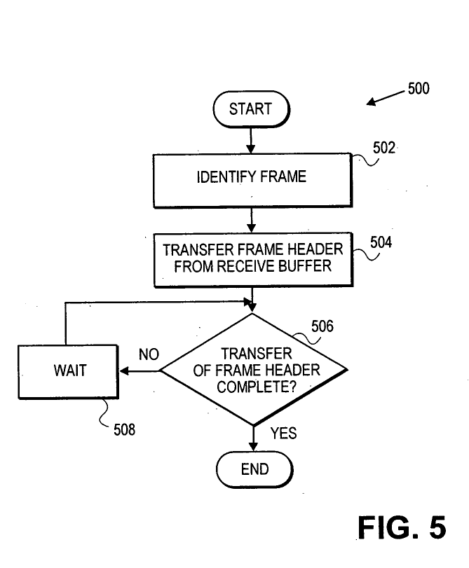

Thus, it is advantageous for one thread to have exclusive access to a shared memory location prior to access by other threads. Accordingly, a thread should not execute a phase until the thread receives a NPS from a parallel thread that has already completed that phase. However, a thread may execute a phase without receiving a NPS when the phase does not involve the potential modification of data in a shared memory location (an example of such a phase is described in connection with FIG. 5.)

For example, a processor may be used to reassemble frames into a packet. In this case, a first phase of the thread, for example, is responsible for identifying a frame and transferring the frame's header to a register. The second phase of the thread, for example, is responsible for determining where to store the payload of the frame being reassembled, so that the payload is stored with other payloads belonging to the same packet. The third phase of the thread, for example, is responsible for storing the frame payload and for determining whether the frame being processed arrived at the processor in the correct order relative to other frames belonging to the same packet, so that the packet can be reassembled properly. If the frame did not arrive in the correct order, the packet to which the frame belongs is damaged and cannot be reassembled. A final phase of the thread, for example, is responsible for discarding a damaged packet, or indicating that an undamaged packet has been reassembled and is ready for additional processing.

During packet reassembly, frames belonging to the same packet may arrive at the processor one followed immediately by another, rather than being interleaved with frames belonging to other packets. During the example second phase mentioned above, threads processing two frames belonging to the same packet access context data (defined below) in a shared memory location, so that frame payloads belonging to the same packets are stored in the correct locations for reassembly. Thus, it is advantageous that a first thread processing a first frame has exclusive access to the shared memory location when it is accessing context data, and that the second thread does not execute its second phase to access the context data until the second thread receives a NPS from the first thread, indicating that the first thread has executed the second phase.

Using multiple threads and multiple phases enables a processor to process data units faster, because while one thread is completing a phase, and/or waiting for a NPS, another thread that has received a NPS can execute one of its phases. Consequently, the processor need not wait for completion of one operation prior to performing another operations, as in the prior art. In addition, in the prior art, a thread scheduler typically is used in a program having multiple threads. A thread scheduler indicates to each thread when the thread may perform an operation. However, use of one or more next phase signals as described herein eliminates the need for a thread scheduler, because the NPS indicates to each thread when to execute a phase.

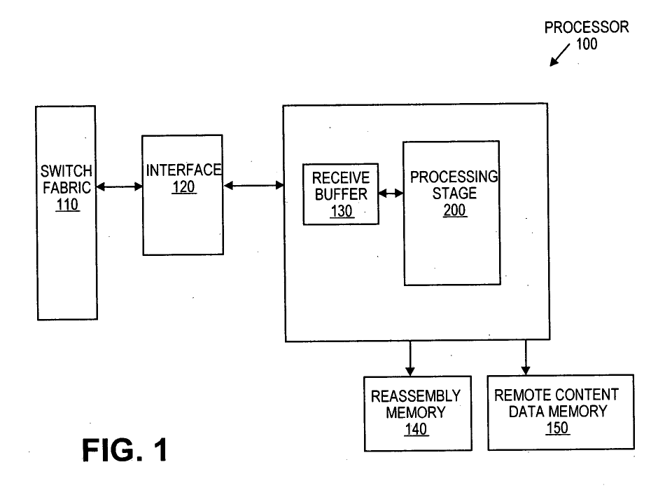

FIG. 1 is a block diagram illustrating a processor according to an embodiment of the invention. External to processor 100 are switch fabric 110 and interface 120. Switch fabric 110 receives data units that arrive at a network device from a source or from another network device, and transmits data units to the next network device or to a destination. Interface 120 connects processor 100 with switch fabric 110.

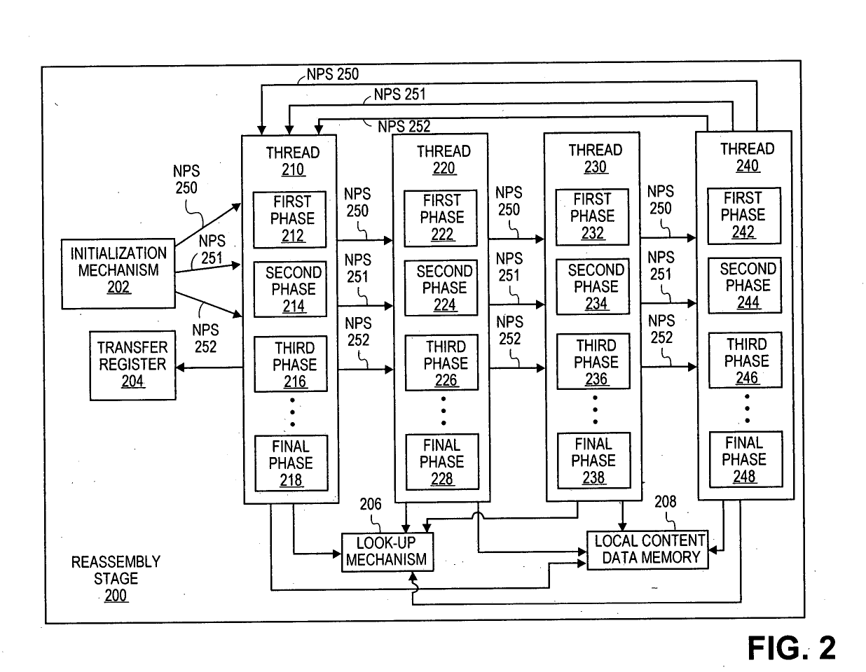

Processor 100 includes receive buffer 130, which receives incoming data units from switch fabric 110 via interface 120. Processor 100 further includes processing stage 200. FIG. 2 is a block diagram illustrating processing stage 200 according to an embodiment of the invention. Processing stage 200 includes initialization mechanism 202, which is described below. Processing stage 200 further includes transfer register 204, which is used to transfer data to and from processing stage 200, e.g., to or from receive buffer 130. Although only one transfer register is shown in FIG. 2 for purposes of illustration and ease of reference, processing stage 200 may include multiple transfer registers.

Processing stage 200 further includes thread 210, thread 220, thread 230, through final thread 249. Thread 210 represents the first thread of processing stage 200; threads 220 and 230 represent any number of additional threads, and final thread 249 represents the final thread in processing stage 200. There is no restriction or requirement regarding the number of threads in processing stage 200, e.g., it may include only thread 210 and final thread 249.

Thread 210 processes a data unit beginning at first phase 212, followed by second phase 214, third phase 216, and a fourth phase, the final phase 218; thread 220 processes another data unit beginning at first phase 222, through a fourth phase, the final phase 228; etc. Once a thread has completed one phase, the thread moves to the next phase, under the circumstances described below. There may be any number of additional phases executed by a thread following the first phase. In addition, there is no restriction or requirement regarding the number of phases in a thread, e.g., it may include only a first phase and a final phase.

Processing stage 200 further includes next-phase signal (NPS) 250, NPS 251 and NPS 252. A NPS indicates to a thread that the thread may execute the phase following the phase the thread is executing presently or has finished executing. A thread is said to be “in a phase” whether the thread is executing the phase presently or has finished executing the phase.

The NPS received by a thread depends upon the current phase being executed by the thread. Specifically, if a thread is in a first phase, the thread receives NPS 250 to indicate that the thread may execute the second phase. If a thread is in a second phase, the thread receives NPS 251 to indicate that the thread may execute a third phase. If a thread is in a third phase, the thread receives NPS 252 to indicate that the thread may execute a final phase. Because there are no restrictions or requirements regarding the number of phases in a thread, there are no restrictions or requirements regarding the number of different next-phase signals to indicate that the thread may execute a phase. In addition, although one embodiment of the invention is described in terms of using different next-phase signals depending on the phase a thread is waiting to execute, an embodiment of the invention may also be practiced using a single NPS to indicate that a thread may execute a next phase, regardless of the phase a thread is waiting to execute.

Initially, all threads are inactive when thread 210 becomes active to process a new data unit. Initialization mechanism 202 provides NPS 250, NPS 251 or NPS 252 to thread 210 when all threads are inactive. Initialization mechanism 202 provides the respective next phase signals to execute first phase 212, second phase 214 and third phase 216. Initialization mechanism 202 can be implemented as either a controller or initialization code.

Once the threads are active, an NPS-ready thread receives NPS 250, NPS 251 or NPS 252 from a parallel thread. The parallel thread transmits the NPS when the parallel thread completes the phase the NPS-ready thread is waiting to execute. For example, when thread 220 is in first phase 222, it receives NPS 250 from thread 210 when thread 210 completes second phase 214, to indicate that thread 220 may now execute second phase 224. When thread 220 is in second phase 224, it receives NPS 251 from thread 210 when thread 210 completes third phase 216, to indicate that thread 220 may now execute third phase 226. When thread 220 is in third phase 226, it receives NPS 252 from thread 210 when thread 210 completes final phase 218, to indicate that thread 220 may now execute final phase 228.

When final thread 249 completes a phase and transmits a NPS, the NPS wraps around to be received by thread 210, since there is no thread following final thread 249. Thus, when final thread 249 completes second phase 244, it transmits NPS 250 to thread 210, to indicate that thread 210 may execute second phase 214. When final thread 249 completes third phase 246, it transmits NPS 251 to thread 210, to indicate that thread 210 may execute third phase 216, and when final thread 249 completes final phase 248, it transmits NPS 252 to thread 210, to indicate that thread 210 may execute final phase 218.

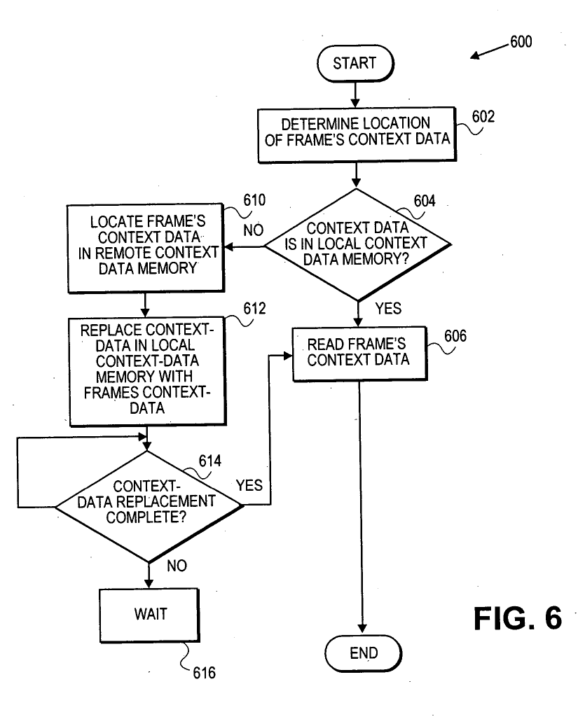

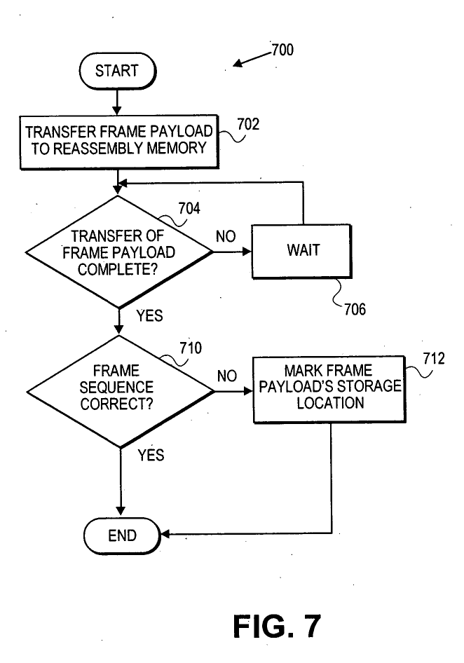

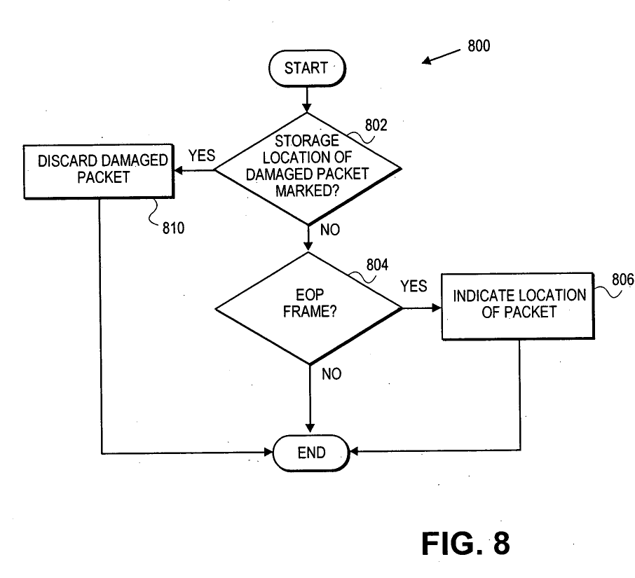

For purposes of illustration and ease of explanation, the remainder of processing stage 200 will be described in terms of reassembling frames into a packet. However, processing stage 200 may be used to process data units in some other manner, or to reassemble other types of data units into other types of larger data units. An example of a first phase for reassembling frames into a packet is described in connection with FIG. 5. An example of a second phase for reassembling frames into a packet is described in connection with FIG. 6, while an example of a third phase for reassembling frames into a packet is described in connection with FIG. 7. An example of a final phase for reassembling frames into a packet is described in connection with FIG. 8.

When processing stage 200 is used to reassemble frames into a packet, processor 100 is externally coupled with reassembly memory 140 and remote context-data memory 150. Reassembly memory 140 is a storage location for frame payloads to be reassembled into packets. In one embodiment, frame payloads belonging to one packet are stored in contiguous locations in reassembly memory 140, while frames belonging to another packet are stored in another contiguous location in reassembly memory 140. However, frame payloads belonging to the same packet may be stored in noncontiguous memory locations and linked by a data structure such as a pointer. In one embodiment, reassembly memory 140 is dynamic random access memory (DRAM). However, reassembly memory 140 may be memory other than DRAM, e.g., static random access memory (SRAM) or flash memory.

Remote context-data memory 150 is a storage location for context data. Context data indicates the location in reassembly memory 140 to store the payload of each frame being processed, so that frame payloads belonging to the same packet are stored in the proper locations to reassemble the packet. For example, context data may indicate the storage location for the payload of each particular frame being processed, or it may indicate the storage location of the payload for the next frame arriving at a particular port. In one embodiment, remote context-data memory 150 is SRAM. However, remote context-data memory 150 may be memory other than SRAM, e.g., DRAM or flash memory. In one embodiment, reassembly memory 140 and remote context-data memory 150 are external to processor 100. However, reassembly memory 140 or remote context-data memory 150, or both, could be internal to processor 100. In addition, reassembly memory 140 and remote context-data memory 150 could be combined into a single memory element.

When reassembling frames into packets, reassembly stage 200 further includes look-up mechanism 206, such as content addressable memory, for determining the location of context data, and local context-data memory 208, which is a context data storage location on processor 100.

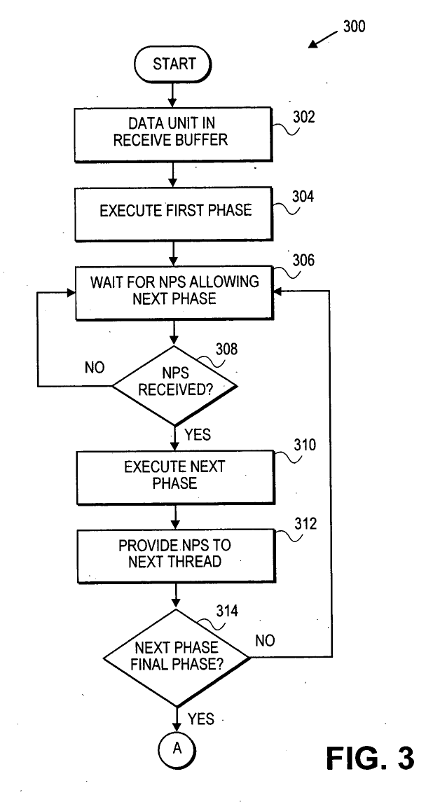

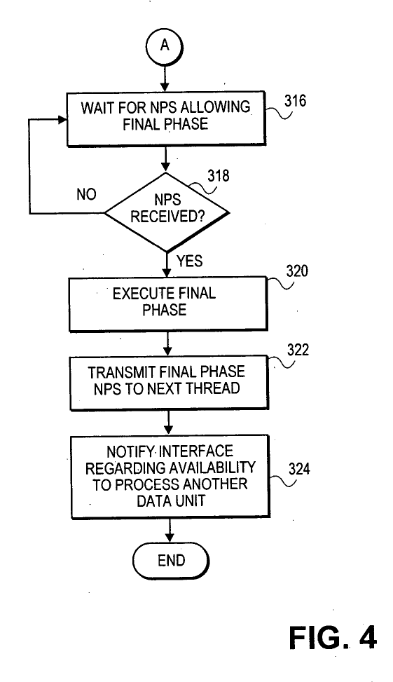

FIG. 3 and FIG. 4 are a flow chart illustrating a method of processing data units according to an embodiment of the invention. At 302 of method 300, a data unit from switch fabric 110 flows via interface 120 into receive buffer 130. In one embodiment, the data unit is a frame, e.g., a common switch interface (CSIX) frame (or C-frame). See, e.g., Network Processing Forum, “CSIX-L1: Common Switch Interface Specification-L1,” Aug. 5, 2000). However, an embodiment of the invention may be used to process other types of data units. In addition, an embodiment of the invention may be used to process other types of frames, including, but not limited to, asynchronous transfer mode (ATM) frames. See, e.g., International Telecommunications Union Telecommunication Standardization Sector (ITU-T), Recommendation I.326, “Functional Architecture of Transport Networks Based on ATM,” November 1995.

At 304, thread 210 executes first phase 212. According to this embodiment of the invention, first phase 212 does not involve potential modification of data in a shared memory location. Consequently, thread 210 can execute first phase 212 without receiving a NPS. At 306, when first phase 212 is complete, thread 210 waits for NPS 250, indicating that thread 210 may execute the next phase, in this case, second phase 214. At 308, thread 210 determines whether it has received a NPS, in this case NPS 250. If thread 210 has not received the NPS, it continues to wait at 306.

If thread 210 has received NPS 250, at 310, thread 210 executes second phase 214. After executing second phase 214, at 312, thread 210 provides NPS 250 to a next thread, in this case, thread 220, which indicates that thread 220 may execute phase 224. At 314, the next processing block depends upon whether the next phase is final phase 218. If the next phase is not final phase 218, at 306, thread 210 waits for an NPS, in this case, NPS 251, and proceeds with method 300 as described above to execute one or more other phases, e.g., third phase 216, and provide one or more next phase signals to a next thread, e.g., provide NPS 251 to thread 220, to indicate that thread 220 may execute third phase 226.

When at 314 the next phase is final phase 218, at 316 thread 210 waits for NPS 252. At 318, thread 210 determines whether it has received NPS 252. If not, thread 210 continues to wait at 316. Once thread 210 has received NPS 252, thread 210 executes final phase 218 at 320. At 322, thread 210 provides NPS 252 to thread 220, which indicates that thread 220 may execute final phase 228. At 324, thread 210 indicates to interface 120 that thread 210 is available to process another data unit.

For purposes of illustration and ease of explanation, the following phases will be explained in terms of reassembling frames into a packet. However, phases may be used to process data units in some other manner. In addition, phases may be used to reassemble other types of data units, e.g., reassembling packets into a segment.

FIG. 5 is a flow chart illustrating a method of a first phase according to an embodiment of the invention. At 502 of method 500, a thread identifies a frame in receive buffer 130, based, e.g., on the information in the frame header, such as the number of the port through which the frame arrived at network device 100. At 504, the thread transfers the frame header from receive buffer 130 to transfer register 204. At 506, the thread determines whether the transfer of the frame header to transfer register 204 is complete. If the frame header transfer is not complete, at 508, the thread waits, and returns to 506 to determine whether the frame header transfer is complete. When the frame header transfer is complete, method 500 ends.

FIG. 6 is a flow chart of a method of a second phase according to an embodiment of the invention. At 602 of method 600, a thread determines the location of a frame's context data. Typically, there is a large amount of context data. Consequently, some of the context data is stored in local context-data memory 208, while the remainder is stored in another location, e.g., remote context-data memory 150.

At 604, the thread determines whether the context data is stored in local-context data memory 208. In one embodiment, the thread accesses look-up mechanism 206 and, using information identifying the frame, e.g., information in the frame header, issues a look-up to determine whether there is an entry corresponding to the frame's identification information, thus indicating that context data for the frame is stored in local context-data data memory 208. In an alternative embodiment, the thread accesses local context-data memory 208 directly to determine whether a memory location includes the frame's context data. If the frame's context data is stored in local context-data memory 208, the thread does not have to retrieve context data from external memory, such as remote context data memory 150, which allows for faster frame processing. At 606, the thread reads the frame's context data.

On the other hand, if the frame's context data is not stored in local context-data memory 208, at 610 the thread uses the frame's identifying information to locate the frame's context data in remote context-data memory 150. At 612, the thread replaces context data in local context-data memory 208 (e.g., the least recently accessed context data) with context data for the frame being processed, and updates look-up mechanism 206 accordingly, to possibly allow another thread to access context data locally rather than remotely, thus allowing for faster frame processing.

At 614, the thread determines whether the context data replacement is complete. If the context data replacement is not complete, at 616, the thread waits, and returns to 614 to determine whether the context data replacement is complete. When the context data replacement is complete, at 606, the thread reads the frame's context data.

FIG. 7 is a flow chart of a method of a third phase according to an embodiment of the invention. At 702 of method 700, a thread transfers a frame's payload from receive buffer 130 to the location in reassembly memory 140 indicated by the frame's context data. At 704, the thread determines whether the transfer of the frame payload to reassembly memory 140 is complete. If the frame payload transfer is not complete, at 706, the thread waits, and returns to 704 to determine whether the frame payload transfer is complete. When the frame payload transfer is complete, at 710, the thread determines whether the frame sequence is correct, i.e., whether the frame arrived at processor 100 in the correct sequential order relative to the other frames that make up the packet to which the current frame belongs, by, for example, checking a frame sequence number in the frame header. If the frame sequence is correct, method 700 ends.

On the other hand, if at 710 the frame sequence is not correct, at 712, the thread marks, for example, using a pointer, the storage location of the frame's payload in reassembly memory 140. The storage location is marked because the frames that comprise the packet have been received out of order, and thus the packet is damaged, because the packet cannot be reassembled.

FIG. 8 is a flow chart of a method of a final phase according to an embodiment of the invention. At 802 of method 800, a thread determines whether the storage location in reassembly memory 140 has been marked to indicate the storage of a damaged packet. If a storage location has been so marked, then at 810, the thread discards the damaged packet from reassembly memory 140.

However, if a storage location of a damaged packet has not been marked, thereby indicating an undamaged packet, then at 804, the thread determines whether the packet's most-recently processed frame is at the end of the packet (an EOP frame), for example, by checking information in the frame header. If the frame is an EOP frame, then a reassembled packet is stored in reassembly memory 140. At 806, the thread indicates the location of the packet in reassembly memory 140, e.g., so that the packet may be accessed for further processing. Thread may indicate the location of the packet, for example, by transmitting a signal, e.g., to another processing stage, or by using a pointer.

Conversely, if, at 804 the frame is not an EOP frame, then the frame is either at the start of the packet, or in the middle of the packet. The packet remains in reassembly memory 140 until other frame payloads belonging to the same packet are stored in reassembly memory 140. The packet will be reassembled, or discarded if one of the frames arrives at processor 100 out of sequence.

FIG. 3-FIG. 8 describe example embodiments of the invention in terms of a method. However, one should also understand it to represent a machine-accessible medium having recorded, encoded or otherwise represented thereon instructions, routines, operations, control codes, or the like, that when executed by or otherwise utilized by an electronic system, cause the electronic system to perform the methods as described above or other embodiments thereof that are within the scope of this disclosure.

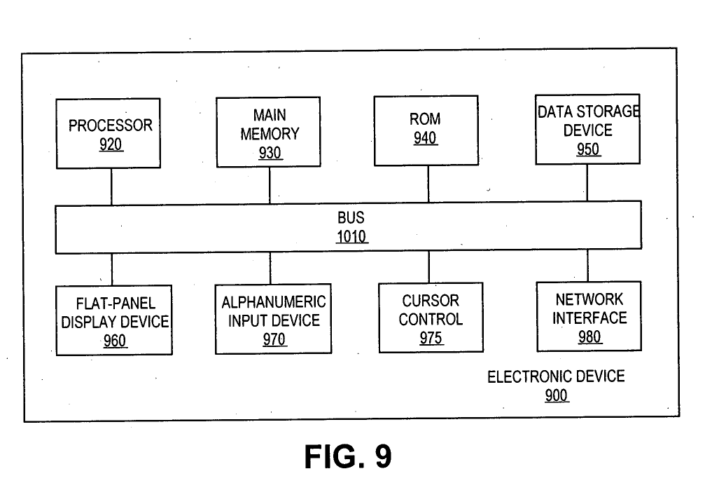

FIG. 9 is a block diagram of one embodiment of an electronic system. The electronic system is intended to represent a range of electronic systems, including, for example, a personal computer, a personal digital assistant (PDA), a laptop or palmtop computer, a cellular phone, a computer system, a network access device, etc. Other electronic systems can include more, fewer and/or different components. The methods of FIG. 3-FIG. 8 can be implemented as sequences of instructions executed by the electronic system. The sequences of instructions can be stored by the electronic system, or the instructions can be received by the electronic system (e.g., via a network connection). The electronic system can be coupled to a wired or wireless network.

Electronic system 900 includes a bus 910 or other communication device to communicate information, and processor 920 coupled to bus 910 to process information. While electronic system 900 is illustrated with a single processor, electronic system 900 can include multiple processors and/or co-processors.

Electronic system 900 further includes random access memory (RAM) or other dynamic storage device 930 (referred to as memory), coupled to bus 910 to store information and instructions to be executed by processor 920. Memory 930 also can be used to store temporary variables or other intermediate information while processor 920 is executing instructions. Electronic system 900 also includes read-only memory (ROM) and/or other static storage device 940 coupled to bus 910 to store static information and instructions for processor 920. In addition, data storage device 950 is coupled to bus 910 to store information and instructions. Data storage device 950 may comprise a magnetic disk (e.g., a hard disk) or optical disc (e.g., a CD-ROM) and corresponding drive.

Electronic system 900 may further comprise a display device 960, such as a cathode ray tube (CRT) or liquid crystal display (LCD), to display information to a user. Alphanumeric input device 970, including alphanumeric and other keys, is typically coupled to bus 910 to communicate information and command selections to processor 920. Another type of user input device is cursor control 975, such as a mouse, a trackball, or cursor direction keys to communicate direction information and command selections to processor 920 and to control cursor movement on flat-panel display device 960. Electronic system 900 further includes network interface 980 to provide access to a network, such as a local area network or wide area network.

Instructions are provided to memory from a machine-accessible medium, or an external storage device accessible via a remote connection (e.g., over a network via network interface 980) providing access to one or more electronically-accessible media, etc. A machine-accessible medium includes any mechanism that provides (i.e., stores and/or transmits) information in a form readable by a machine (e.g., a computer). For example, a machine-accessible medium includes RAM; ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the embodiments of the invention. Thus, the embodiments of the invention are not limited to any specific combination of hardware circuitry and software instructions.

Reference in the foregoing specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, are to be regarded in an illustrative rather than a restrictive sense.

1. a method for processing network data, comprising:
receiving a first execution signal to execute a phase of a thread to process a first data unit;
executing the phase, in response to receiving the first execution signal; and
transmitting, when the phase is complete, a second execution signal to a parallel thread, to indicate that the parallel thread may execute a corresponding phase to process a second data unit.

2. The method of claim 1, wherein receiving the first execution signal to execute the phase to process the data unit comprises receiving the first execution signal from a different parallel thread that has executed another corresponding phase to process a third data unit.

3. The method of claim 1, wherein receiving the first execution signal to execute the phase to process the data unit comprises receiving the first execution signal from an initialization mechanism.

4. The method of claim 1, further comprising receiving an activation signal from an interface to activate the thread.

5. The method of claim 1, wherein receiving the first execution signal to execute the phase to process the data unit comprises receiving the first execution signal to execute the phase to process a frame.

6. The method of claim 5, wherein executing the phase, in response to receiving the first execution signal, comprises:
identifying the frame, based at least in part on information in a header of the frame; and
transferring the header to a register.

7. The method of claim 5, wherein executing the phase, in response to receiving the first execution signal, comprises:
determining, based at least in part on information identifying the frame, a memory location of context data that indicates a storage location at which to store a payload of the frame, wherein the payload of the frame is stored with other payloads of other frames belonging to a packet, for reassembly into the packet;
replacing locally-located context data with remotely-located context data for the frame, if determining that the memory location of the context data for the frame is remote rather than local; and
reading the context data for the frame.

8. The method of claim 5, wherein executing the phase, in response to receiving the first execution signal, comprises:
transferring a frame payload to a memory location;
determining whether a sequence of the frame is correct; and
marking the memory location, if the sequence of the frame is incorrect, as storing a damaged packet.

9. The method of claim 5, wherein executing the phase, in response to receiving the first execution signal, comprises:
discarding a packet, wherein the frame belongs to the packet, if a storage location of the packet is identified as storing a damaged packet;
determining whether the frame is an end frame of the packet, if the storage location is unmarked to indicate an undamaged packet; and
indicating the storage location of the packet, if the frame is the end frame of the packet.

10. A method for processing network data, comprising:
executing a first phase of a first thread to process a first frame;
receiving a first execution signal to execute a second phase of the first thread to process the first frame, from a second thread that has executed a corresponding second phase to process a second frame;
executing the second phase, in response to receiving the first execution signal; and
transmitting to a third thread, when the second phase is complete, a second execution signal to indicate that the third thread may execute another corresponding second phase to process a third frame.

11. The method of claim 10, wherein receiving the first execution signal to execute the second phase to process the frame comprises receiving the first execution signal from an initialization mechanism.

12. The method of claim 11, further comprising:
receiving from the second thread a second third execution signal to execute a third phase of the first thread to process the frame, wherein the second thread has executed a corresponding third phase to process the second frame; and
transmitting to the third thread, when the third phase is complete, a fourth execution signal to indicate that the third thread may execute another corresponding third phase to process the third frame.

13. The method of claim 12, further comprising:
receiving from the second thread a fifth execution signal to execute a final phase of the first thread to process the first frame, wherein the second thread has executed a corresponding final phase to process the second frame;
transmitting to the third thread, when the final phase is complete, a sixth execution signal to indicate that the third thread may execute another final phase to process the third frame.

14. A processor, comprising:
a receive buffer, to receive a data unit units;
a first thread having a first phase and a second phase, the first thread to:
execute the first phase to process a first data unit,
receive a first execution signal,
execute, as a result of receiving the signal, the second phases, and
transmit, when the second phase is complete, a second execution signal to a second thread;
the second thread, having a first corresponding first phase and a first corresponding second phase, the second thread to:
execute the first corresponding first phase to process a second data unit,
receive the second execution signal,
execute, as a result of receiving the second execution signal, the first corresponding second phase, and
transmit when the first corresponding second phase is complete, a third execution signal to a third thread; and
the third thread, having a second corresponding first phase and a second corresponding second phase, the third thread to:
execute the second corresponding first phase to process a third data unit,
receive the third execution signal,
execute, as a result of receiving the third execution signal, the second corresponding second phase and
transmit, when the second corresponding second phase is complete, the first execution signal to the first thread.

15. The processor of claim 14, further comprising a transfer register, to receive a header of a data unit from the receive buffer.

16. The processor of claim 14, further comprising an initialization mechanism, to provide the first execution signal to the first thread.

17. The processor of claim 14, further comprising:
a look-up mechanism, to indicate a memory location of context data; and
a context data memory, to store the context data.

18. An article of manufacture comprising:
a machine-accessible medium including thereon sequences of instructions that, when executed, cause an electronic system to:
receive a first execution signal to execute a phase of a thread to process a first data unit;
execute the phase, in response to receiving the first execution signal; and
transmit, when the phase is complete, a second execution signal to a parallel thread, to indicate that the parallel thread may execute a corresponding phase to process a second data unit.

19. The article of manufacture of claim 18, wherein the sequences of instructions that, when executed, cause the electronic system to receive the first execution signal to execute the phase to process the first data unit, comprise sequences of instructions that, when executed, cause the electronic system to receive, from a different parallel thread that has executed another corresponding phase to process a third data unit, the first execution signal to execute the phase to process the first data unit.

20. The article of manufacture of claim 18, wherein the sequences of instructions that, when executed, cause the electronic system to execute the phase, in response to receiving the first execution signal, comprise sequences of instructions that, when executed, cause the electronic system to:
identify the data unit, based at least in part on information in a header of the data unit; and
transfer the header to a register.

21. The article of manufacture of claim 20, wherein the machine-accessible medium further comprises sequences of instructions that, when executed, cause the electronic system to:
determine, based at least in part on information identifying the data unit, a memory location of context data that indicates a storage location at which to store a payload of the data unit, wherein the payload of the data unit is stored with other payloads of other frames belonging to a packet, for reassembly into the packet;
replace locally-located context data with remotely-located context data for the data unit, if determining that the memory location of the context data for the data unit is remote rather than local; and
read the context data for the data unit.

22. The article of manufacture of claim 21, wherein the machine-accessible medium further comprises sequences of instructions that, when executed, cause the electronic system to:
transfer the payload of the data unit to a memory location;
determine whether a sequence of the data unit is correct; and
mark the memory location, if the sequence of the data unit is incorrect, as storing a damaged packet.

23. The article of manufacture of claim 22, wherein the machine-accessible medium further comprises sequences of instructions that, when executed, cause the electronic system to:
discard the packet, wherein the data unit belongs to the packet, if a storage location of the packet is identified as storing the damaged packet;
determine whether the data unit is an end data unit of the packet, if the storage location is unmarked to indicate an undamaged packet; and
indicate the storage location of the packet, if the data unit is the end data unit of the packet.

24. An article of manufacture comprising:
a machine-accessible medium including thereon sequences of instructions that, when executed, cause an electronic system to:
execute a first phase of a first thread to process a first frame;
receive a first execution signal to execute a second phase of the first thread to process the first frame, from a second thread that has executed a corresponding second phase to process a second frame;
execute the second phase, in response to receiving the first execution signal; and
transmit to a third thread, when the second phase is complete, a second execution signal to indicate that the third thread may execute another corresponding second phase to process a third frame.

25. The article of manufacture of claim 24, wherein the machine-accessible medium further comprises sequences of instructions that, when executed, cause the electronic system to:
receive from the second thread a third execution signal to execute a third phase of the first thread to process the frame, wherein the second thread has executed a corresponding third phase to process the second frame; and
transmit to the third thread, when the third phase is complete, a fourth execution signal to indicate that the third thread may execute another corresponding third phase to process the third frame.

26. The article of manufacture of claim 25, wherein the machine-accessible medium further comprises sequences of instructions that, when executed, cause the electronic system to:
receive from the second thread a fifth execution signal to execute a final phase of the first thread to process the first frame, wherein the second thread has executed a corresponding final phase to process the second frame;
transmit to the third thread, when the final phase is complete, a sixth execution signal to indicate that the third thread may execute another final phase to process the third frame.

27. A system, comprising:
a processor, wherein the processor comprises:
a receive buffer, to receive units;
a first thread having a first phase and a second phase, the first thread to:
execute the first phase to process a first data unit,
receive a first execution signal,
execute, in response to receiving the first execution signal, the second phase, and
transmit, when the second phase is complete, a second execution signal to a second thread;
the second thread, having a first corresponding first phase and a first corresponding second phase, the second thread to:
execute the first corresponding first phase to process a second data unit,
receive the second execution signal,
execute, as a result of receiving the second execution signal, the first corresponding second phase, and
transmit when the first corresponding second phase is complete, a third execution signal to a third thread; and
the third thread, having a second corresponding first phase and a second corresponding second phase, the third thread to:
execute the second corresponding first phase to process a third data unit,
receive the third execution signal,
execute, as a result of receiving the third execution signal, the second corresponding second phase, and
transmit, when the second corresponding second phase is complete, the first execution signal to the first thread; and
a context data memory, coupled with the processor, to store context data, wherein the context data memory comprises flash memory.

28. The system of claim 27, wherein the processor further comprises:
a look-up mechanism, to indicate a memory location of the context data; and
a local context data memory, to store the context data.

29. The system of claim 27, wherein the processor further comprises an initialization mechanism, to provide the first execution signal to the first thread.

30. The method of claim 1, wherein the first execution signal and the second execution signal comprise a same signal.

31. The method of claim 10, wherein the first execution signal and the second execution signal comprise a same signal.

32. The processor of claim 14, wherein the first execution signal, the second execution signal and the third execution signal comprise a same signal.

33. The article of manufacture of claim 18, wherein the first execution signal and the second execution signal comprise a same signal.

34. The article of manufacture of claim 24, wherein the first execution signal and the second execution signal comprise a same signal.

35. The system of claim 27, wherein the first execution signal, the second execution signal and the third execution signal comprise a same signal.
